(19) United States
(12) Patent Application Publication
(10) Pub. No.: US 2007/0215057 A1
(43) Pub. Date: Sep. 20, 2007

(54) Animal odor filtration unit

(75) Inventors: Joseph A. Geer, Nokesville, VA (US); Jack H. Geer, Nokesville, VA (US)

Correspondence Address: BLANKENSHIP LAW, PLLC, 2815 HARTLAND ROAD, SUITE 120, FALLS CHURCH, VA, 22043, US

(73) Assignee: NodorGeer LLC, Nokesville, VA (US)

(21) Appl. No.: 11/377,962

(22) Filed: Mar. 17, 2006

(51) Int. Cl. A01K 29/00

(52) U.S. Cl. 119/165

(57) ABSTRACT

The present invention is directed to a unit for eliminating offensive odors. An electrostatic filter assembly embodiment of the present invention includes a casing, a substantially sheer electrostatic filter sheet, and a substantially silent blower. A filtered animal litter box embodiment of the present invention includes an enclosure, a filter assembly, a conduit, a filter cartridge, and a substantially silent blower. A kit of parts having components of the filtered animal box is also contemplated.

### FIELD OF THE INVENTION

The present invention relates to the field of animal odor control and more specifically to the field of filtering cat-related bathroom odors.

### BACKGROUND

Cat urine and feces have a pungent odor capable of spreading many meters beyond the confines of a traditional litter box. The litter box is currently the most prominent means of controlling cat-related odors. A cat litter box allows a homeowner to centralize all of the offensive cat odor in one location and mask the causes of those odors with a fillable medium. The prevailing cat litter box medium is made of clay, which is dusty and pebbly. Clay-based litter comes in one of two varieties traditional litter and clumping litter.

Traditional clay cat litter has existed since about the 1950's and is one of the oldest types of commercial cat litter. Traditional cat litter ought to be sifted every day in search of deposits and should be completely replaced monthly. Clumping litter arrived commercially later than traditional cat litter and had one distinct advantage: wet particles would “clump” together to form a solid mass, which is simple to scoop away. There is not a need to replace an entire box of clumping cat litter as there is with traditional cat litter; instead, one replacing clumping litter would need to remove only the solid masses, which are the only portions of the litter contacted by cat urine, etc.

With either type of cat litter, traditional or clumping, there is a significant amount of time between feline deposits and deposit removal. Unfortunately, the fragrance of deposits within a cat litter box offends the typical human's nose. Numerous methods have been devised to alter the smell of cat litter boxes, including the addition of pleasant fragrances to the cat litter. Urine and fecal smells are hard to mask; such fragrance additives rarely solve the odor problem. The chemical components of feces and urine make disguising their odor extremely challenging.

The components of feces include organic substances that comprise other elements particularly offensive to the human sense of smell. These elements could range from the particularly pungent Sulfur, to the more tame-smelling Nitrogen and Phosphorous. Feces also includes butyl mercaptan, which is the primary component of the skunk odor. Urine components include urea and ammonium, both of which eventually transform into ammonia when exposed to the atmosphere. The formidable catalogue of pungent components of cat bathroom deposits demonstrates the low likelihood of successfully masking cat bathroom deposits by simply adding fragrances.

Successfully combating cat deposit odor ought to involve methods and structure beyond innovation in litter box filler material. A promising means to control animal odor involves locating filtration means proximate to animal deposit enclosures. Multiple animal containment designs exist that attempt to mask animal odors using odor filtration, odor evacuation, and the like. Information relevant to attempts to address these problems can be found in U.S. Pat. Nos. 6,227,147; 5,738,040; 5,655,478; 5,564,364; 5,315,964; 5,307,761; 5,140,948; 5,134,972; and 5,044,325. However, each one of these references suffers from one or more of the following disadvantages: inability to ventilate odors; inability to effectively ventilate odors; cat-intimidating noisiness; inability to filter odor; inability to effectively filter odors; required use of rapidly expendable, odor-absorbing material, inflexible gaseous transport; reliance on large, cumbersome filters; and the like. Therefore, there is a need for a method and device that effectively filters animal odors in a substantially quiet manner and is capable of using manageable, inexpensive filters.

### SUMMARY

The present invention is directed to a unit for eliminating offensive odors. An electrostatic filter assembly embodiment of the present invention includes a casing, a substantially sheer electrostatic filter sheet, and a substantially silent blower. The casing of the electrostatic filter assembly has an odor inlet and an exhaust. The odor inlet is an opening that allows gases from the environment surrounding the electrostatic filter assembly inside the electrostatic filter assembly. The exhaust is an opening that allows gases that have passed through the substantially sheer electrostatic filter sheet to return to the environment from which they first arrived.

The substantially sheer electrostatic filter sheet is located within the casing and contacts gas flowing from the odor inlet to the exhaust. The substantially sheer electrostatic filter sheet is configured to be removed and placed by a user in the casing. The blower of the present invention operates at a decibel level that does not offend the often finicky emotions of the typical cat. The blower is positioned to urge air into the odor inlet, through the substantially sheer electrostatic filter sheet, and then out of the exhaust.

Electrostatic filter assembly embodiments might further include a filter cartridge adapted to hold a substantially sheer electrostatic filter sheet. The filter cartridge can be positioned within the electrostatic filter assembly and then removed at the whim of a user. Of the myriad structural possibilities of a filter cartridge for use in the electrostatic filter assembly, two are preferred: a jointed filter cartridge; and a separable filter cartridge. The jointed filter cartridge has a first filter panel and a second filter panel; each is connected to the other by a hinge that allows joint-like motion. The separable filter cartridge includes a male filter panel that removably attaches to a female filter panel.

An intended use of the electrostatic filter assembly is to remove animal odor, especially in coordination with an enclosed litter box. The embodiments of the electrostatic filter assembly might additionally include a conduit capable of attaching to both the odor inlet and an enclosed litter box.

A filtered animal litter box embodiment of the present invention includes an enclosure, a filter assembly, a conduit, a filter cartridge, and a substantially silent blower. The enclosure is a covering that allows an animal to enter and exit, via an animal passage, and leave bathroom deposits within. Versions of the enclosure might include either a view port and a maintenance port. The enclosure also has an odor outlet that connects to a conduit. The conduit conducts odors from the enclosure to an odor inlet located on the casing of the filter assembly.

The filter assembly of the filtered animal litter box includes the casing, the odor inlet, and an exhaust. The odor inlet has an opening that allows gases conducted from the conduit to enter the filter assembly. The exhaust is an opening that allows gases that have passed through the substantially sheer electrostatic filter sheet to return to the environment from which they first arrived. The preferred filter assembly has a screen covering the exhaust. The filter assembly further has an opening that allows a filter cartridge to rest within the filter assembly and be removed at the convenience of a user. Certain embodiments of the animal litter box filter assembly include a filter assembly positioner, a device to fix the position of the filter assembly to a household structure.

A substantially silent blower of the filtered animal litter box urges gas from the enclosure through the exhaust. Although it has been found that the best position for the blower is proximate to the exhaust; any position capable of fulfilling the function of urging gas from the enclosure through the exhaust will suffice. The preferred blower of all embodiments of the present invention is a fan producing less than ten decibels of sound.

The preferred filtered animal litter box is capable of using multiple types of sheet filters. It is preferred that a sheet filter bear an electrostatic charge. The preferred electrostatically charged filter is a substantially sheer electrostatic filter sheet.

The filter cartridge of the filtered animal litter box is constructed to accept a sheet filter and then allow a user to remove the sheet filter at the user's convenience. The preferred filtered animal litter box filter cartridge uses either the jointed filter cartridge design, separable filter cartridge design, or the slide-fit filter cartridge design. The slide-fit filter cartridge includes a bay that allows a sheet filter to simply slide into the filter.

An additional embodiment of the present invention to includes a kit of parts for a filtered animal litter box having the enclosure, the filter assembly, the conduit, the filter cartridge, and the substantially silent blower. The kit could additionally include the filter assembly positioner or any other component of the present invention disclosed herein.

Therefore, it is an aspect of the present invention to present a economical alternative to filter offensive odors from the air.

It is a further aspect of the present invention to minimize one of the chief negative aspects of pet ownership: offensive pet smells.

It is a still further aspect of the present invention to present a filter capable of lengthy use.

It is a still further aspect of the present invention to present a filtration unit capable of utilizing filters that occupy minimal space.

It is a still further aspect of the present invention to present a filtration unit capable of flexible positioning that allows distance to be placed between the filter and any enclosures to which the filter might connect.

It is a still further aspect of the present invention to have a substantially silent filtration system that is sonically friendly to pets.

These aspects of the invention are not meant to be exclusive. Additionally, some aspects may apply to particular versions or embodiments, but not other versions or embodiments. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is an exploded, isometric view of an electrostatic filter assembly.

FIG. 2 is a isometric view of an embodiment of the electrostatic filter assembly.

FIG. 3 is an isometric view of an embodiment of the electrostatic filter assembly showing internal components.

FIGS. 4A, 4B, and 4C respectively include a perspective, orthogonal, and orthogonal view of an embodiment of a jointed filter cartridge.

FIGS. 5A, 5B, and 5C respectively include a perspective, orthogonal, and perspective view of an embodiment of a separable filter cartridge.

FIGS. 6a and 6B are perspective views of an embodiment of a slide-fit filter cartridge.

FIG. 7 is a perspective view of a filter assembly.

FIG. 8 is a perspective view of a filtered animal litter box.

FIG. 9 is a perspective view of a filtered animal litter box kit.

### DETAILED DESCRIPTION

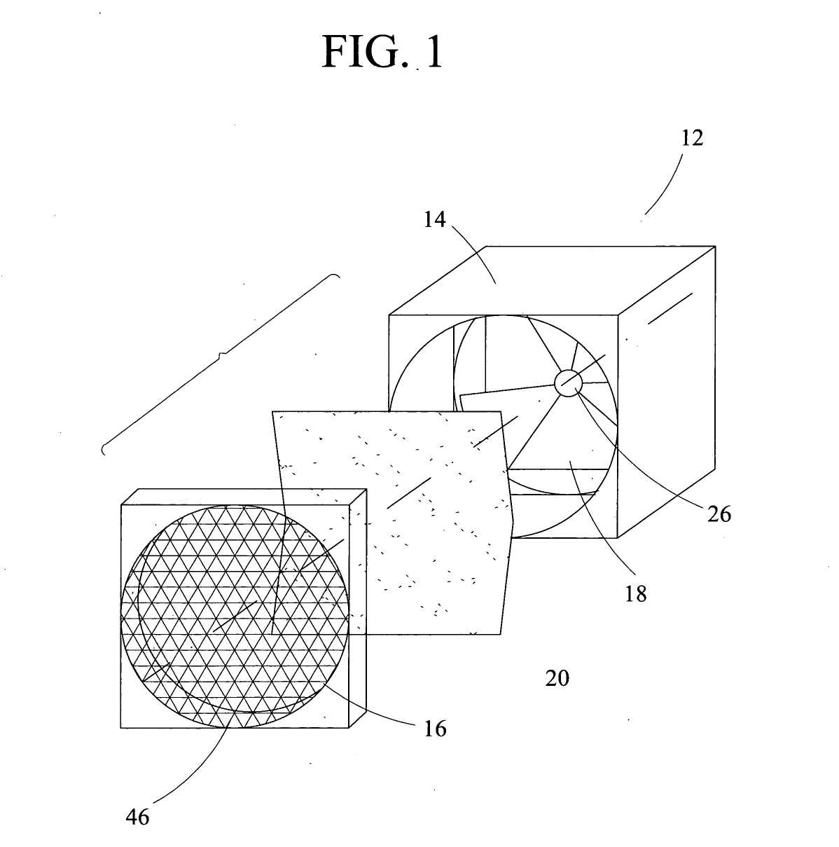

Referring first to FIG. 1, an embodiment of an electrostatic filter assembly 12 is shown. The electrostatic filter assembly embodiment 12 includes an electrostatic filter sheet 20, a casing 14 with an odor inlet 16 and exhaust 18, and a substantially silent blower 26.

The substantially sheer electrostatic filter sheet 20 of the electrostatic filter assembly serves as the medium by which offensive air is purged of contaminants. By substantially sheer, it is meant that the filter is essentially a planar entity of minimal thickness. The preferred substantially sheer electrostatic filter of the present invention is pliable, which allows a user to more easily manipulate the filter and also allow for creative manufacturing of the internal structure of the electrostatic filter assembly. A pliable, substantially sheer electrostatic filter will adapt to a variety of shapes on which it might be pressed. The substantially sheer electrostatic filter sheet best achieves its function when positioned within the electrostatic filter assembly to contact a prominent portion of the air passing from the odor inlet 16 to the exhaust 18.

The preferred substantially sheer electrostatic filter is a conventional, commercial dryer sheet. Dryer sheets are substantially sheer, pliable, electrostatically charged, inexpensive, and generally contain pleasant scents.

The casing 14 serves as the protective covering for the electrostatic filter assembly. In fulfilling this purpose the preferred casing is constructed of a hard material such as wood, plastic, metal, or the like. The size of the preferred electrostatic filter assembly embodiments adapted to accept dryer sheets is limited by the size of conventional, commercial dryer sheets. The dimension of commercial dryer sheets are typically on the order of seven inches by nine inches. Versions of the electrostatic filter assembly using dryer sheets could have casings adapted to accept portions of dryer sheets or folded dryer sheets.

The configuration of the casing should be such that a substantial portion of air is forced to pass through the substantially sheer electrostatic filter sheet 20 within the casing 14. However, the size and width of the conventional, commercial dryer sheets do not influence the basic embodiment of the electrostatic filter assembly, which can support embodiments containing portions of dryer sheets or any substantially sheer electrostatic filter sheet.

The casing 14 of the electrostatic filter assembly 12 has an odor inlet 16 and an exhaust 18. The preferred casing 12 of the electrostatic filter assembly is configured so as to orient the electrostatic filter assembly's internal components as shown in FIG. 1: the odor inlet 16 that first contacts offensive air, the substantially sheer electrostatic filter sheet 20 between the odor inlet 16 and the substantially, silent blower 26, and the exhaust 18 located directly proximate to the blower 26. The electrostatic filter assembly is not limited to the aforementioned arrangement; any orientation of internal components fulfilling the purpose of filtering air will suffice. For example, certain embodiments of the electrostatic filter assembly may position the blower immediately proximate to the odor inlet to blow, rather than pull as in the preferred embodiment, air through the substantially sheer electrostatic filter sheet and then out via the exhaust.

The odor inlet 16 has an opening that allows gases from the environment surrounding the electrostatic filter assembly 12 to enter the electrostatic filter assembly 12. The exhaust 18 is an opening that allows gases that have passed through the substantially sheer electrostatic filter sheet 20 to return to the environment from which the gases first arrived. There is no preferred size or shape of either the odor inlet or exhaust; each needs to be merely an opening to allow the passage of gases, e.g. household air. It is preferred that any exposed holes of the present invention be sized to prevent human body parts, especially fingers, entrance into the interior of the electrostatic filter assembly. It is preferred that large openings be covered with a vent. FIG. 1 shows a vent 46 protecting the odor inlet 16, though versions of the present invention sporting a having a conduit connecting to the odor inlet need not include a vent.

The blower 26 of all embodiments of the present invention is a device that urges air from a selected location to the odor inlet 16 and out through the exhaust 18. As previously mentioned, the preferred position for the blower in the electrostatic filter assembly 12 is immediately proximate to the exhaust 18 and the substantially sheer electrostatic filter sheet 20, i.e. not between the substantially sheer electrostatic filter sheet 20 and the odor inlet 16. This preferred positioning orients the blower 26 in a position to contact air that has already passed through the substantially sheer electrostatic filter sheet 20, which prevents particles from rapidly accruing on the blower 26. The blower 26 is any device capable of urging air through the electrostatic filter assembly 12.

The preferred substantially silent blower is a computer fan. Computer fans are ideal because they typically are relatively silent, yet operate at relatively powerful speeds. Cats are naturally skittish creatures and are easily frightened by loud noises. The size, speed, and power of a blower will depend upon the needs of the user. It has been found that a fan with five fan blades, processing a 150 cubic feet per minute airflow, operating at 45-50 decibels, achieves that the purpose of the present invention, particularly when in fluid communication with an enclosed litter box having the dimensions of a medium size to large size pet carrier. Computer fans commonly operate at less than thirty decibels, and the preferred fan of the electrostatic filter assembly operates at less than ten decibels.

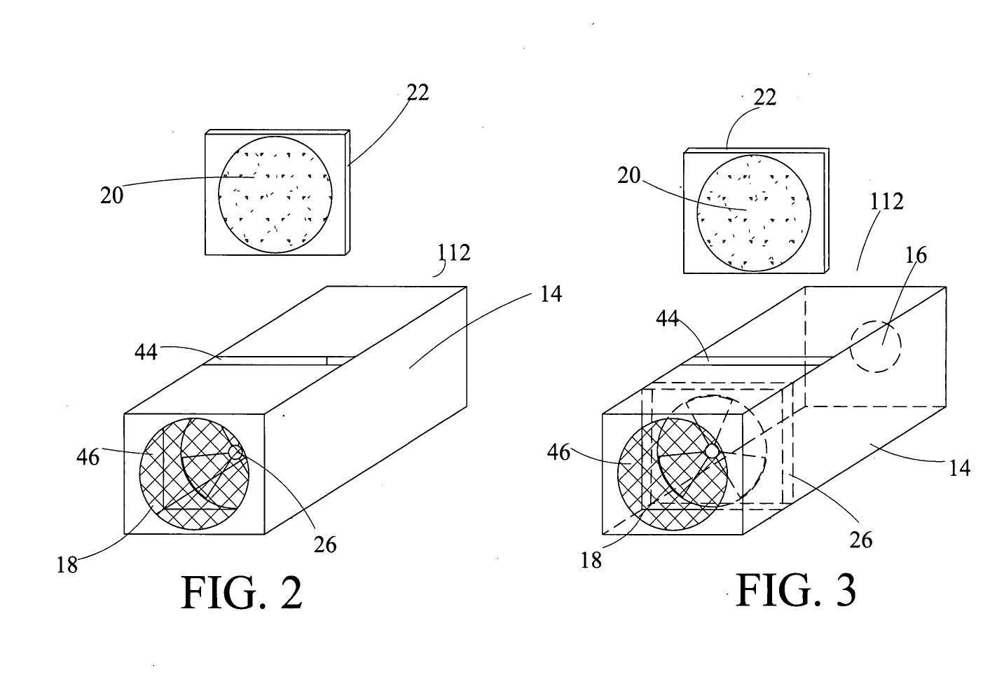

As shown in FIG. 2, versions of the electrostatic filter assembly 112 may additionally include a filter cartridge 22. Although the filter cartridge 22 of the electrostatic filter assembly is structured to hold the substantially sheer electrostatic filter sheet 20, other embodiments of the filter cartridge 22 may hold other types of sheet filters. The function of the filter cartridge of the electrostatic filter assembly 112 is to position a substantially sheer electrostatic filter sheet 20 within the electrostatic filter assembly 112. The preferred casing 14 of electrostatic filter assembly embodiments designed to work in conjunction with a filter cartridge 22 includes a slot 44 adapted to accept the filter cartridge 22. Because the filter cartridge 22 of the electrostatic filter assembly 112 must be capable of bracing a substantially sheer electrostatic filter sheet 20, the filter cartridge 22 must be constructed of a self-supporting material. It is preferred that the filter cartridge is constructed of a harder material such as metal, wood, or plastic. The configuration of the filter cartridge 22 of the electrostatic filter assembly can be any structural design that allows a user to conveniently slip a substantially sheer electrostatic filter sheet 20 into and out of the filter cartridge 22.

FIG. 3 shows the internal components of the embodiment pictured in FIG. 2. The filter cartridge 22 has a preferred location that is positioned between the blower 26 and the odor inlet 16. In the pictured embodiment, the odor inlet 16 includes no protective covering, but the exhaust 18 does include a vent 46.

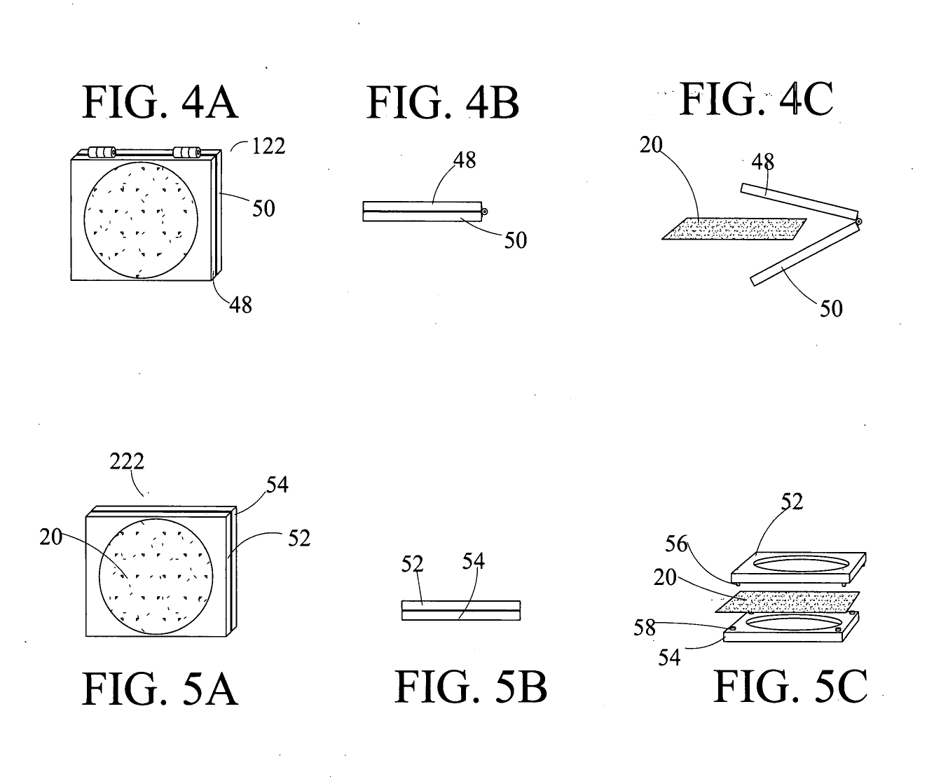

FIGS. 4A, 4B, 4C, 5A, 5B, 5C, 6A, and 6B show various filter cartridges of the present invention. Although filter cartridges of the electrostatic filter assembly configured to accept any type of sheet filter. A significant trait of all cartridge filters is that they allow a substantial portion of airflow to contact whatever sheet filter is disclosed within.

FIGS. 4A, 4B, and 4C show an embodiment of a jointed filter cartridge 122. The jointed filter cartridge 122 includes a first filter panel 48 and a second filter panel 50. The first filter panel and the second filter panel connect by a hinge that allows joint-like motion. As FIG. 4C demonstrates, a user need only lift one panel from the other to remove or place a filter within. Jointed filter cartridge embodiments 122 of the electrostatic filter assembly would necessarily have panels dimensioned to position fairly to close to one another, as shown in FIG. 4B. Other jointed filter cartridge embodiments would be constructed based on the dimensions of a predetermined sheet filter.

FIGS. 5A, 5B, and 5C show an embodiment of a separable filter cartridge 222. The separable filter cartridge includes a male filter panel 52 that removably attaches to a female filter panel 54. The male filter panel 52 includes various male fittings 56 configured to fasten within female fittings 58 located upon the female filter panel 58. In embodiments using magnets as fittings, the male fittings and female fittings will be for practical purposes indistinguishable. In such magnetic embodiments, the male magnetic fittings will maintain a specific magnetic charge, while the female magnetic fitting—to which the male magnetic fitting will mate—will have the opposite magnetic charge. Dimensioned to nestle between the two panels is the sheet filter, shown as the substantially sheer electrostatic filter sheet 20. Other separable filter cartridge embodiments need not have panels dimensioned to position as closely.

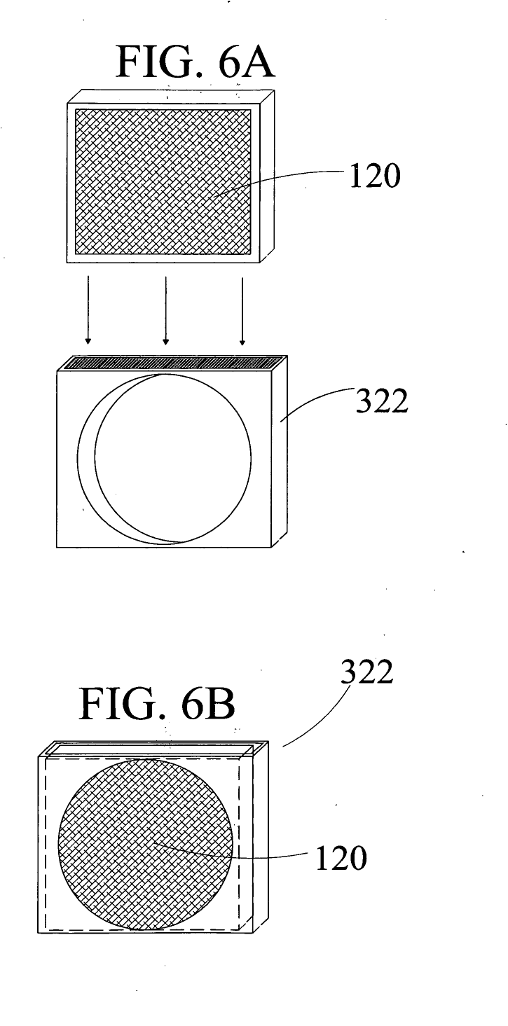

FIGS. 6A and 6B show a slide-fit filter cartridge 322. The slide fit filter cartridge 322 includes a substantially hollow bay that is structured to allow a filter to fit therein, shown here as a sheet filter 120. A portion of a side of the slide-fit filter cartridge 322 should include an opening to allow a sheet filter 120 to slide into the bay of the slide-fit cartridge 322.

The sheet filter, when part of or meant to be used with, the present invention is meant to include any filter having a thinness in one dimension relative to the other two dimensions of the filter. The sheet filter must be capable of filtering particles from the air. Preferred filter materials may include dense fiberglass or polyester media, pleated media, HEPA, activated carbon, cotton gauze, vegetable fibers, synthetic fibers, charged plastic film or fiber, or any other air cleaners used in the art of air purifying. The term sheet filter, as used in this disclosure, is understood to include substantially sheer electrostatic filter sheets.

The preferred filter material is electrostatically charged. As air passes through an electrostatic medium, the medium produces friction that creates a natural static charge, i.e. electrostatic charge. The static charge attracts tiny particles to the filter like a magnet. These particles comprise irritants such as dust, dust mites, pollen, fabric lint, tobacco smoke, plant spores, and pet dander and odor.

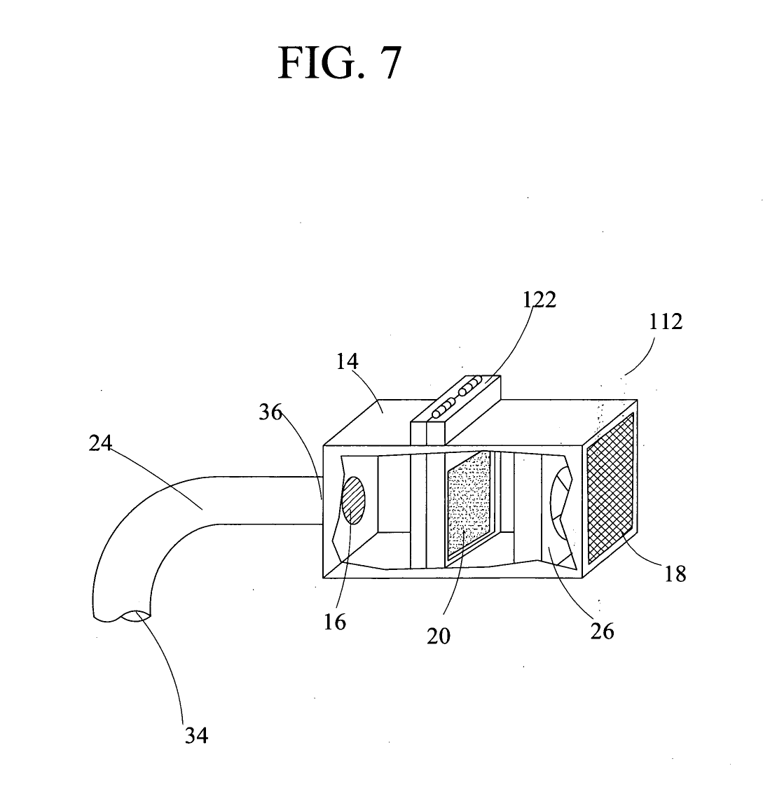

As shown in FIG. 7, the certain versions of the electrostatic filter assembly 112 further include a conduit 24 attached to the odor inlet 16 with a filter assembly coupling end 36. As a significant use of the electrostatic filter assembly is to remove animal odor, embodiments of the present invention should be capable of removing gas from within enclosed space. The conduit 24 acts as a means for transporting gas, i.e. air, from a foreign source without losing a substantial portion of that gas. Transporting gases from one predetermined area to a second predetermined area is also termed “fluid communication” within this disclosure.

The preferred material for the conduit 24 includes any flexible medium generally used in the construction of pipes, particularly preferred are rubber, flexible PVC pipe, and dryer vent pipes. Rigid pipes may be used in embodiments of the present invention, but it is an aspect of other embodiments that the electrostatic filter assembly be repositionable at the convenience of a user. Both the filter assembly coupling end 36 and a litter box attachment end 34 include means for fastening the conduit 24. The preferred means for fastening the conduit to either a filter assembly or a animal litter box includes size fitting; that is to say that the conduit couples to other apparatuses by being sized to barely fit therein or thereon. The conduit, when it is a rubber hose, could be stretched to fit over a nipple. Alternatively, the filter assembly coupling end 36 and the litter box attachment end 34 could include threaded portions capable of fitting one onto the other.

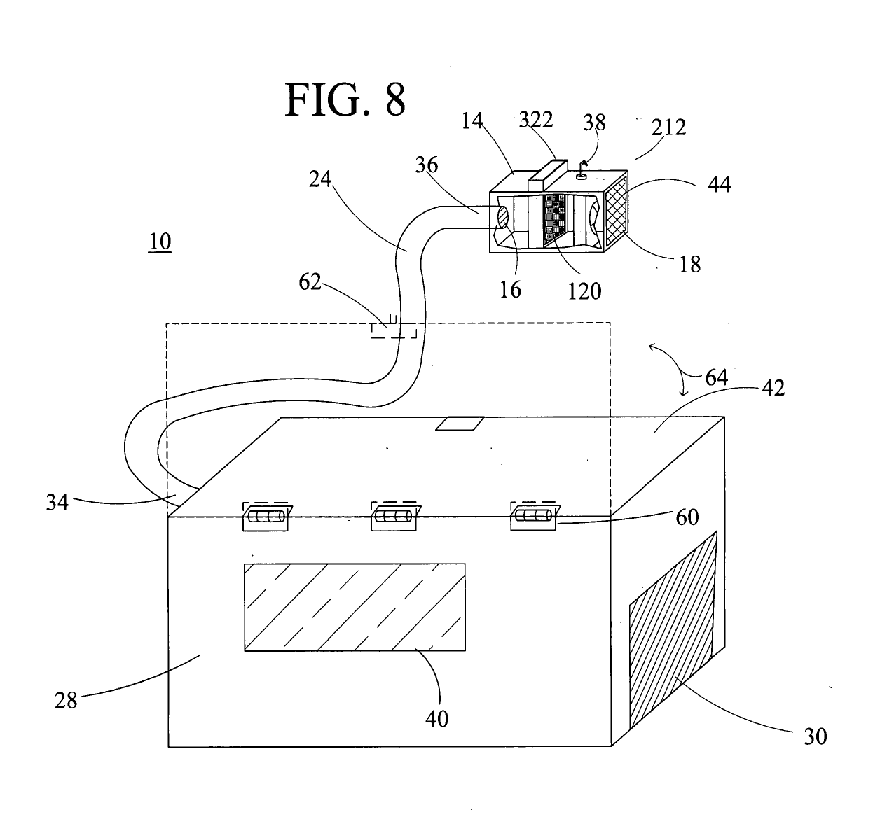

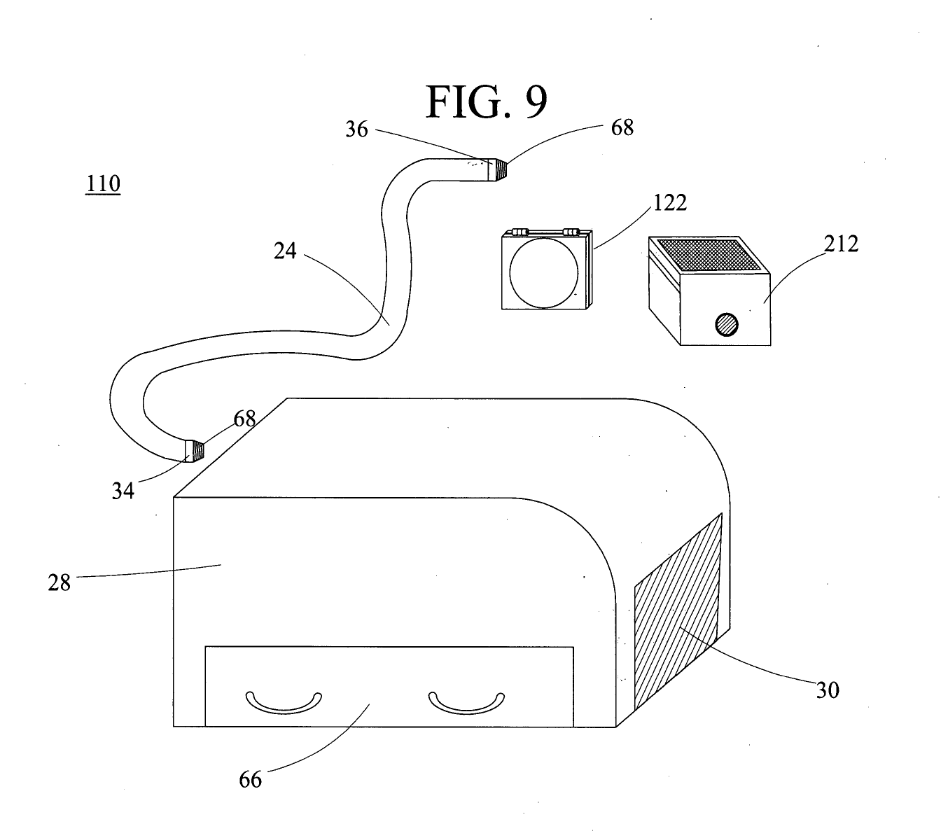

FIG. 8 depicts a filtered animal litter box 10 embodiment of the present invention having an enclosure 28, a filter assembly 212, a conduit 24, a filter cartridge 322 (shown as the slide fit filter cartridge), and a substantially silent blower 26.

The enclosure 28 is a covering that allows an animal to enter and exit, via an animal passage 30, and leave bathroom deposits within. The animal passage 30 can be sized for a cat, rodent, or small-sized dog. There is no preferred location for the animal passage, as animals may enter enclosures in many varied ways. The enclosure can be composed of any self-supporting material, but the preferred materials include wood and plastic.

Embodiments of the filtered animal litter box 10 may additionally feature a view port 40, which is preferably glass or any translucent material that allows a user to view the interior of the enclosure. Other embodiments of the filtered animal litter box 10 could include an enclosure 28 having a maintenance port 42. The maintenance port 42 is a means for a user to rearrange, replace, or alter the contents of the enclosure 28. The preferred maintenance port 42 is pictured in FIG. 8 as comprising two components: a latch 62 and a series of hinges 60. The hinges 60 allow axial motion 64 of a portion of the enclosure 28 away from itself. The latch 62 allows a user to lock the enclosure into a static entity. An alternative maintenance port includes a drawer, shelf, or other like device capable of reciprocating motion to reveal contents within the enclosure. The drawer embodiment would be particularly advantageous to versions of the enclosure designed to house cat litter.

Within the enclosure 28 is a odor outlet (not shown) that allows odors from the enclosure to be urged into the conduit 24. From the conduit 24, gases from the enclosure 28 are fluidly transferred to odor inlet 16 on the casing 14 of the filter assembly 212.

The filter assembly 212 of the filtered animal litter box 10 is substantially identical to the electrostatic filter assembly previously discussed within this disclosure with the exception that the filter assembly of the animal litter box is dimensioned to accept a greater variety of filter cartridges and accompanying filters. The filtered animal litter box 10 pictured in FIG. 8 contains the slide fit filter cartridge 322 and a sheet filter 120. Embodiments of the filter assembly 212 could include a filter assembly positioner 38, which is a device capable of fixing the position of the filter assembly to a household structure. The filter assembly positioner could be a hook (as shown in FIG. 8) for mounting from an overhang, brackets for mounting to a vertical structure, or some other fastening device.

A substantially silent blower 26 is located on the present invention to urge gas from the enclosure 28 through the exhaust 18. There is no preferred or single blower location, either in the filter assembly 212 or the enclosure 28; any position capable of fulfilling the function of urging gas from the enclosure 28 through the exhaust 18 will suffice.

FIG. 8 shows a kit of parts 110 of the present invention. The filtered animal litter box kit 110 includes the enclosure 28, the filter assembly 212, the conduit 24, the filter cartridge 122, and the substantially silent blower (not shown). The kit could additionally include any other component of the present invention disclosed herein.

The pictured conduit 24 features the filter assembly coupling end 36 and a litter box attachment end 34 with male threaded fasteners 68 as the means for fastening the conduit 24. The enclosure of FIG. 8 further demonstrates the previously mentioned drawer maintenance port 66.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. An electrostatic filter assembly for substantially eliminating offensive odors, said filter assembly comprising:
a casing with an odor inlet and an exhaust;
a substantially sheer electrostatic filter sheet, removably positioned within said casing to substantially and uniformly contact gas flowing from said odor inlet to said exhaust, and
a substantially silent blower positioned to urge fluid communication from said odor inlet through said exhaust.

2. The electrostatic filter assembly of claim 1 further comprising a filter cartridge, removably positionable within said filter assembly, adapted to releasably accept said substantially sheer electrostatic filter sheet.

3. The electrostatic filter assembly of claim 2 wherein said filter cartridge comprises a first filter panel jointedly connected to a second filter panel.

4. The electrostatic filter assembly of claim 2 wherein said filter cartridge comprises a male filter panel removably attached to a female filter panel.

5. The electrostatic filter assembly of claim 1 further comprising a conduit, fluidly positioned proximate to said odor inlet, having a filter assembly coupling end; and said conduit further comprising a litter box enclosure attachment end.

6. The electrostatic filter assembly of claim 5 wherein said substantially sheer electrostatic filter sheet is pliable.

7. A filtered animal litter box comprising:
an enclosure defining an animal passage and an odor outlet;
a filter assembly having a casing with an odor inlet and exhaust;
a conduit, connected to both said odor inlet and said odor outlet, allowing fluid communication between said enclosure and said filter assembly;
a filter cartridge, removably positioned within said filter assembly, adapted to releasably accept a sheet filter; and
a substantially silent blower positioned to urge fluid communication from said enclosure through said exhaust.

8. The filtered animal litter box of claim 7 wherein said filter cartridge is adapted to releasably accept a substantially sheer electrostatic filter sheet.

9. The filtered animal litter box of claim 7 further comprising a substantially sheet electrostatic filter sheet removably disposed within said filter cartridge.

10. The filtered animal litter box of claim 7 wherein said filter cartridge comprises a first filter panel jointedly connected to a second filter panel.

11. The filtered animal litter box of claim 7 wherein said filter cartridge comprises a male filter panel removably attached to a female filter panel.

12. The filtered animal litter box of claim 7 wherein said conduit is composed of a flexible material.

13. The filtered animal litter box of claim 12 wherein said filter assembly includes a filter assembly positioner.

14. The filtered animal litter box of claim 7 wherein said enclosure further comprises a view port.

15. The filtered animal litter box of claim 7 wherein said enclosure further comprises a maintenance port.

16. The filtered animal litter box of claim 7 wherein said filter assembly further comprises a screen positioned to contact gas emanating through said exhaust.

17. The filtered animal litter box of claim 7 wherein said blower is a fan, affixed within said filter assembly, producing less than thirty decibels of sound.

18. The filtered animal litter box of claim 17 wherein said blower is a fan producing less than ten decibels of sound.

19. A kit of parts for a filtered animal litter box, said kit comprising:
an enclosure defining an animal passage and an odor outlet;
a filter assembly having a casing with an odor inlet and exhaust;
a conduit, dimensioned to connect to both said odor inlet and said odor outlet, allowing fluid communication between said enclosure and said filter assembly;
a filter cartridge, dimensioned to be removably positioned within said filter assembly, adapted to releasably accept a sheet filter; and
a substantially silent blower positioned to urge fluid communication from said enclosure through said exhaust.

20. The kit of parts of claim 19 wherein said filter cartridge is adapted to releasably accept a substantially sheer electrostatic filter sheet.
